(19) United States
(12) Patent Application Publication
(10) Pub. No.: US 2010/0134009 A1
(43) Pub. Date: Jun. 3, 2010

(54) MIXED LIGHT LAMP

(75) Inventor: Andreas Kloss, Neubiberg (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/532,154

(22) PCT Filed: Apr. 10, 2008
(86) PCT No.: PCT/EP2008/002852

§ 371 Date: Jan. 8, 2010

(30) Foreign Application Priority Data
Apr. 13, 2007 (DE) 10 2007 017 497.9

(51) Int. Cl. H01J 7/44

(52) U.S. Cl. 315/51; 315/56

(57) ABSTRACT

A mixed light lamp may include an outer bulb, in which a filament and a discharge vessel are accommodated in series, the discharge vessel having a metal halide fill, the lamp furthermore being assigned a rectifier, an energy storage means and a starting device, wherein the starting device contains a spiral pulse generator, which is accommodated directly in the outer bulb.

### TECHNICAL FIELD

The invention is based on a mixed light lamp in accordance with the preamble of claim 1. Such mixed light lamps can be used in particular for general lighting.

### PRIOR ART

Mixed light lamps are known, for example, from WO 2005027588. U.S. Pat. No. 4,316,124 deals with the starting of said lamps.

Mixed light lamps are characterized by the series circuit including a high-pressure discharge lamp and an incandescent lamp. The incandescent lamp is used to produce light immediately after starting of the lamp and at the same time to realize the current limitation required for the high-pressure discharge lamp. Such an arrangement can be operated directly on the system voltage supply without any further ballast. If rectification and smoothing is implemented in the power supply (WO 2005027588, U.S. Pat. No. 4,316,124), high-pressure discharge lamps with a metal halide fill can thus also be operated.

The problem associated with the starting of high-pressure discharge lamps is at present solved using two approaches. Discharge lamps with a low starting voltage have a third internal starting electrode, which is connected into the circuit via a resistor (U.S. Pat. No. 4,316,124). Such a design cannot be realized, or can only be realized with great difficulty, for ceramic discharge lamps. Such lamps require an external starting device (WO 2005027588).

The disadvantage with this is the fact that the feedlines need to be designed to withstand high voltages.

In the past, repeated attempts have been made to integrate the starting unit in the lamp. These attempts have included integrating a starting unit in the base. Particularly effective starting which promises high pulses has been successful by means of so-called spiral pulse generators; see U.S. Pat. No. 3,289,015. A relatively long time ago, such devices where proposed for various high-pressure discharge lamps such as metal halide lamps or sodium high-pressure lamps; see U.S. Pat. No. 4,325,004 and U.S. Pat. No. 4,353,012, for example. However, they could not gain acceptance since, firstly, they are too expensive. Secondly, the advantage of incorporating them in the base is insufficient since the problem of supplying the high voltage into the bulb remains. For this reason, the probability of damage to the lamp, whether it be insulation problems or a breakdown in the base, increases severely. Starting devices which have been conventional to date generally could not be heated to above 100° C. The voltage produced would then have to supplied to the lamp, which requires lines and lampholders with a corresponding high-voltage strength, typically approximately 5 kV.

In order to produce particularly high voltages, a double generator is used; see U.S. Pat. No. 4,608,521.

### DESCRIPTION OF THE INVENTION

The object of the present invention is to specify a mixed light lamp which provides immediate light and in the process achieves relatively high efficiency.

This object is achieved by the characterizing features of claim 1.

A mixed light lamp is a combined incandescent lamp and discharge lamp. This means that it has a discharge vessel and a light-emitting element.

What is desired is a mixed light lamp for immediate light emission and comparatively high luminous efficiency which can be operated directly on the 230 V system voltage without a ballast.

Previously mixed light lamps have preferably used a pure mercury high-pressure discharge lamp as the discharge vessel. The entire lamp is accommodated in an elliptical outer bulb flushed with phosphor. The filament, typically made from tungsten, emits light immediately after the lamp is switched on. It also takes on the function of the current-limiting ballast. The mercury high-pressure discharge increasingly takes on part of the light generation with the evaporation of the mercury and together with the phosphor of the outer bulb. Such a design has until now been restricted to the use of mercury high-pressure discharge lamps with a relatively low luminous efficiency and poor color rendering, because only such discharge vessels, with an auxiliary electrode and without any further starting devices, start at a system voltage of 230 V. Occasionally, a metal halide lamp is also used as the discharge vessel in mixed light lamps, as is explained in WO 2005/027588. The mixed light lamp typically also contains a rectifier, a charging capacitor and a starting device. In WO 2005/027588, the starting device is designed in such a way that it has a current-limiting resistor, a zener diode, a capacitor and a coil, i.e. represents a traditional starting circuit.

In order to avoid a voluminous starting device which is accommodated either separately or in the base, it is now firstly proposed to use a mixed light lamp based on a metal halide lamp together with a ceramic spiral pulse generator as the starting device. It is therefore even possible to accommodate all of the components such as the filament, the discharge vessel and the starting device in an outer bulb. It is also possible for components for rectification and smoothing of the lamp current to additionally be accommodated in the outer bulb of the lamp. For this purpose, the diodes preferably need to be designed using SiC technology and the capacitors need to be in the form of ceramic capacitors with a high dielectric constant. The outer bulb is preferably evacuated. Preferably, the outer bulb is frosted, but it does not necessarily need to have a phosphor layer now. The spiral pulse generator enables and ensures the starting of the metal halide lamp.

DE-Az 102005061832.4 and DE-Az 102005061831.6 have disclosed a compact high-voltage pulse generator which can generate high voltages of over 15 kV. In this case, the spiral pulse generators generally include two conductors which are of approximately equal length and are wound in the form of spirals; see FIG. 1. This means that each conductor has approximately the same number of turns. Such a design is necessary for using the vector inversion principle.

DE-Az 102006026750.8 has disclosed using a spiral pulse generator which is surrounded by a ferritic material with a relative permeability of μᵣ=1 to 5000. Express reference is hereby made to these three documents. The principle that a current flowing in the first turn as a result of the short circuit induces a high-voltage pulse in the remaining turns is always used in this case.

When designing a spiral pulse generator for a pulse voltage of approximately 25 kV, the design of a light source with immediate light and in addition a hot-restarting capacity is even made possible. This can be achieved, for example, by a double pulse generator; see U.S. Pat. No. 4,608,521 and in particular also DE-Az 102006026749.4.

The spiral pulse generator now used is in particular a so-called LTCC component or else HTCC component. The LTCC material is a special ceramic which can be made temperature-resistant up to 600° C. Although LTCC has already been used in connection with lamps (see US 2003/0001519 and U.S. Pat. No. 6,853,151), it has been used for entirely different purposes in lamps which are subjected to virtually no temperature loading, with typical temperatures of below 100° C. The particular value of the high temperature stability of LTCC in connection with the starting of high-pressure discharge lamps, such as primarily metal halide lamps with starting problems, has not been discussed in the prior art.

The spiral pulse generator, in terms of is basic design, is a component which combines properties of a capacitor with those of a waveguide for producing starting pulses with a voltage of at least 1.5 kV. In order to produce such a spiral pulse generator, two ceramic “green films” with a metallic conductive paste are printed and then wound in offset fashion to form a spiral and finally isostatically pressed to form a molding. The following co-sintering of metal paste and ceramic film takes place in air in a temperature range of between 800 and 900° C. This processing allows a use range of the spiral pulse generator of up to 700° C. temperature loading. As a result, the spiral pulse generator can be accommodated in the direct vicinity of the discharge vessel in the outer bulb, but also in the base or in the direct vicinity of the lamp.

Irrespective of this, such a spiral pulse generator can also be used for other applications because it is not only stable at high temperatures, but is also extremely compact. It is essential for this that the spiral pulse generator is in the form of an LTCC component part, including ceramic films and metallic conductive paste. In order to produce a sufficient output voltage, the spiral should include at least 5 turns.

In addition, it is possible on the basis of this high-voltage pulse generator to specify a starting unit which furthermore includes at least one charging resistor and a switch. The switch may be a spark gap or else a diac using SiC technology.

In the case of an application for lamps, it is preferred to accommodate the spiral pulse generator in the outer bulb. This is because there is therefore no longer a need for a voltage feedline which withstands high voltages.

In addition, a spiral pulse generator can be dimensioned in such a way that the high-voltage pulse even makes hot-restarting of the lamp possible. The dielectric including ceramic is characterized by an extremely high dielectric constant e of e>10, where an e of typically 70, up to e=5000 can be reached, depending on the material and design. This provides a very high capacitance of the spiral pulse generator and makes possible a comparatively large time span of the pulses produced. This makes a very compact design of the spiral pulse generator possible, with the result that installation in conventional outer bulbs of high-pressure discharge lamps is successful.

The large pulse width also facilitates the flashover in the discharge volume.

Any conventional glass can be used as the material of the outer bulb of a lamp, i.e. in particular hard glass, vycor or quartz glass. The choice of fill is not subject to any particular restriction either.

### BRIEF DESCRIPTION OF THE DRAWINGS

The invention will be explained in more detail below with reference to a plurality of exemplary embodiments. In the figures:

FIG. 1 shows the basic design of a spiral pulse generator as is already known;

FIG. 2 shows the principle for the wiring of a double spiral pulse generator;

FIG. 3 shows the basic design of a spiral pulse generator with an increased starting voltage;

FIG. 4 shows the basic design of a novel mixed light lamp;

FIG. 5 shows the basic design of a rectified mixed light lamp.

### PREFERRED EMBODIMENT OF THE INVENTION

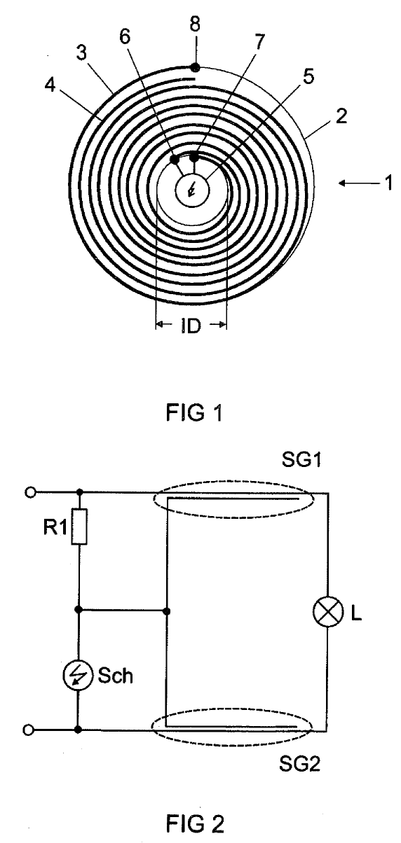

FIG. 1 shows the design of a spiral pulse generator 1 in a plan view. It includes a ceramic cylinder 2, into which two different metallic conductors 3 and 4 have been wound as a film tape in the form of spirals. The cylinder 2 is hollow on the inside and has a given inner diameter ID. The two inner contacts 6 and 7 of the two conductors 3 and 4 are approximately opposite one another and are connected to one another via a spark gap 5.

Only the outer of the two conductors has a further contact 8 at the outer periphery of the cylinder. The other conductor ends open. The two conductors thereby together form a waveguide in a dielectric medium, the ceramic.

The spiral pulse generator is either wound from two ceramic films coated with metal paste or constructed from two metal films and two ceramic films. An important characteristic in this case is the number n of turns, which should preferably be of the order of magnitude of from 5 to 100. This winding arrangement is then laminated and subsequently sintered, as a result of which an LTCC component part is produced. The spiral pulse generators thus produced with a capacitor property are then connected into the circuit with a spark gap and a charging resistor.

The spark gap can be located at the inner or the outer connections or else within the winding of the generator. A spark gap can preferably be used as the high-voltage switch which initiates the pulse.

In a specific exemplary embodiment, a ceramic material with e=60 to 70 is used. In this case, a ceramic film, in particular a ceramic tape such as Heratape CT 707 or preferably CT 765 or else a mixture of the two, in each case by Heraeus, is preferably used as the dielectric. It has a thickness of the green film of typically from 50 to 150 μm. In particular, Ag conductive paste such as “cofirable silver”, likewise by Heraeus, is used as the conductor. A specific example is CT 700 by Heraeus. Good results are also produced by the metal paste 6142 by DuPont. These parts can be laminated easily and then baked (“burnout”) and co-sintered (“co-firing”).

The inner diameter ID of the spiral pulse generator is 10 mm. The width of the individual strips is likewise 10 mm. The film thickness is 50 μm and also the thickness of the two conductors is in each case 50 μm. The charging voltage is 300 V. With these preconditions, the spiral pulse generator reaches an optimum for its properties given a turns number of n=20 to 70.

FIG. 2 shows a spiral pulse generator for high starting voltages.

The invention demonstrates very particular advantages in connection with high-pressure discharge lamps which do not contain any mercury. Such lamps are particularly desirable for reasons of environmental protection. They contain a suitable metal halide fill and in particular a noble gas such as xenon under a high pressure. Owing to the lack of mercury, the starting voltage is particularly high. It is more than 20 kV. At present, attempts are being made to accommodate the components of the starting unit in the base. A spiral pulse generator with an integrated charging resistor can be accommodated either in the base of the mercury-free lamp or in an outer bulb of the lamp.

In this case, the spiral pulse generator for generating the high voltage of, for example, 20 kV preferably has two integrated generators in a single LTCC spiral or another highly thermally resistant material. Since a single generator, which is intended to produce a high-voltage pulse of 20 kV, for example, would have to have a larger outer diameter than the outer diameter of the outer bulb of the lamp, two generators with a push-pull circuit are used (FIG. 2). In this case, two charging resistors R1 and R2 and a switch Sch in the form of a spark gap are used. The two spiral generators acting on the lamp L are denoted by SG1 and SG2. This principle is fundamentally known from U.S. Pat. No. 4,608,521. In said document, however, two separate generators are used.

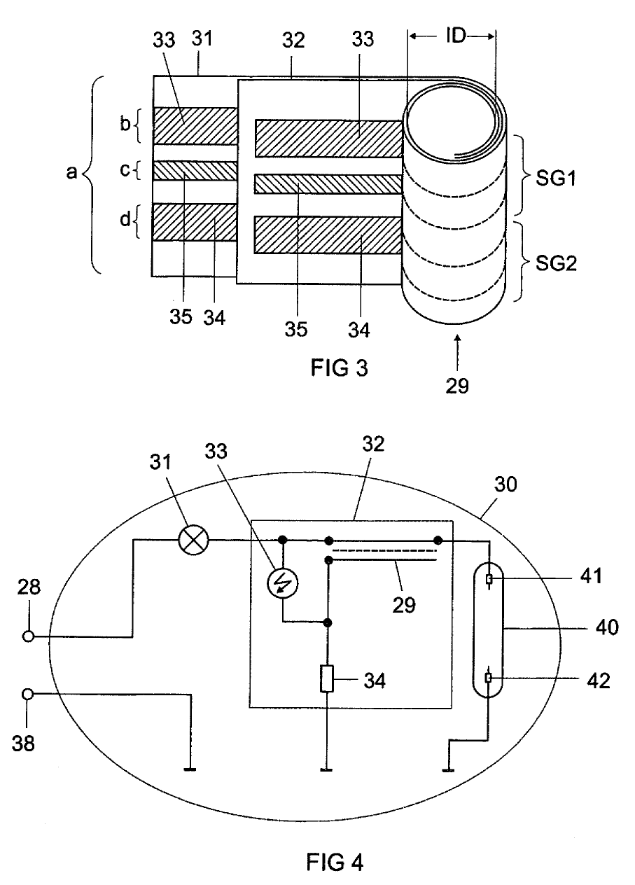

The two generators are now integrated as a single LTCC spiral 29 with two “stacked” conductor planes and if appropriate a possible shield therebetween (FIG. 3). The two ceramic films 31 and 32 are each a wound tape and typically have a width a of from 10 to 50 mm and now simultaneously contain three metallic layers, which run parallel to one another. The first spiral generator SG1 is formed in each case by a first wide layer 33 (typical width b is 3 to 20 mm) of the two films. The second spiral generator SG2 is formed by a second identical layer 34 with a similar width d. In order to be able to keep the distance between the two layers small, a shield in the form of a narrow metal tape 35 (typical width c is from 1 to 5 mm) may be applied between the two layers 33 and 34, as one option.

This double ceramic film 31, 32 is wound up to 100 times, the inner diameter ID of the hollow cylinder produced typically being from 10 to 50 mm.

By using the LTCC technology in a double-layered embodiment, both a temperature resistance of up to 600° C. and a sufficiently small outer diameter are achieved since each individual generator only needs to generate half the required high voltage, for example 10 kV.

The characteristic variables thus change in the direction of providing a more compact structure. Possible dimensions for a single or double spiral pulse generator using LTCC technology are:

| | | |
|---|---|---|
| | Single spiral pulse | Double spiral pulse |
| Feature | generator | generator |

| Turns | 95 | | 48 | |
|---|---|---|---|---|
| Inner diameter | 30 | mm | 15 | mm |
| Outer diameter | 68 | mm | 34 | mm |
| Epsilon eᵣ | 66 | | 66 | |
| Strip width | 20 | mm | 20 | mm |
| Maximum voltage | 20 | kV | 2 × 10 kV = 20 kV | |
| Internal diameter | 100 | mm | 15 | mm |
| Charging voltage | 400 | V | 300 | V |

In both cases, in each case a film thickness of 50 μm and a conductor thickness of likewise 50 μm are used.

In this case, turns numbers of n to 500 are used, with the result that the output voltage reaches up to the order of magnitude of 100 kV. This is because the output voltage U_{A} is provided, as a function of the charging voltage U_{L}, by U_{A}=2×n×U_{L}×η, where the efficiency η is given by η=(AD−ID)/AD.

The invention demonstrates very particular advantages in connection with high-pressure discharge lamps which do not contain any mercury. Such lamps are particularly desirable for reasons of environmental protection. They contain a suitable metal halide fill and in particular a noble gas such as xenon under a high pressure. Owing to the lack of mercury, the starting voltage is particularly high. It is more than 20 kV. At present, attempts are being made to accommodate the components of the starting unit in the base. A spiral pulse generator with an integrated charging resistor can be accommodated either in the base of the mercury-free lamp or in an outer bulb of the lamp.

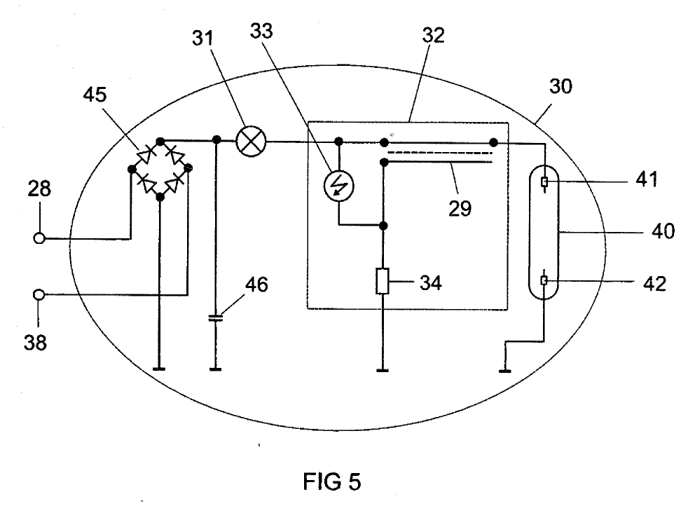

FIG. 4 shows the principle of the novel mixed light lamp. An incandescent lamp 31, in particular a halogen incandescent lamp, or else only a filament is at the same time accommodated in a voluminous outer bulb 30. Said incandescent lamp is connected to a first base contact 29. In series with this, a structural unit comprising a spiral pulse generator, preferably a double pulse spiral pulse generator which is combined with a spark gap 33 or a similar short-circuiting switch and a charging resistor 34, is accommodated as the starting device 32. Both parts can be integrated in a spiral pulse generator, with the result that a particularly compact structural unit is provided. The other end of the spiral pulse generator is connected to an electrode of the discharge vessel, in particular of a metal halide lamp.

Specifically, a 150 W halogen incandescent lamp in combination with a ceramic metal halide lamp of 35 V is suitable.

A line is passed back to the second base contact 38 from the other electrode of the discharge lamp or the discharge vessel.

FIG. 5 shows the basic design of a rectified mixed light lamp. In contrast to FIG. 4, in this case a rectifier 45 and a charging capacitor 46 are also introduced in the outer bulb of the lamp between the lamp contacts 28, 38 which lead to the system input and the incandescent lamp 31. The full-bridge rectifier 45 is connected between the system input and the intermediate-circuit voltage. Its positive input is connected to the supply voltage, and its negative input is connected to ground. The charging capacitor produces an intermediate-circuit voltage between the ground and the supply voltage.

1. A mixed light lamp, comprising: an outer bulb, in which a filament and a discharge vessel are accommodated in series, the discharge vessel having a metal halide fill, the lamp furthermore being assigned a rectifier, an energy storage means and a starting device, wherein the starting device contains a spiral pulse generator, which is accommodated directly in the outer bulb.

2. The mixed light lamp as claimed in claim 1, wherein the spiral pulse generator is a double pulse generator.

3. The mixed light lamp as claimed in claim 1, wherein the starting device contains a short-circuiting switch and a charging resistor.

4. The mixed light lamp as claimed in claim 1, wherein the starting device contains a rectifier and an energy store.

5. The mixed light lamp as claimed in claim 3, wherein the switch is a spark gap.

6. The mixed light lamp as claimed in claim 1, wherein the energy storage means is a charging resistor, which is integrated in the spiral pulse generator.

7. The mixed light lamp as claimed in claim 6, wherein the charging capacitor is a conventional capacitor.

8. The mixed light lamp as claimed in claim 6, wherein the charging capacitor is formed by virtue of the fact that a second metallic conductor is wound on a second, spirally wound ceramic film together with the first ceramic film, but the wound-on length of the second ceramic film is shorter than the wound-on length of the first ceramic film by at least two coils.

9. The mixed light lamp as claimed in claim 1, wherein the starting apparatus is held in the outer bulb by a frame.

10. The mixed light lamp as claimed in claim 1, wherein the high voltage produced by the spiral pulse generator acts directly on two electrodes in the discharge vessel.

11. The mixed light lamp as claimed in claim wherein the voltage produced by the spiral pulse generator acts on an auxiliary starting electrode fitted externally on the discharge vessel.

12. The mixed light lamp as claimed in claim 1, wherein the dielectric constant e of the spiral pulse generator is at least e=10.

13. The mixed light lamp as claimed in claim 1, wherein a series resistor, which limits the charging current of the spiral pulse generator, is also accommodated in the outer bulb.
